(19) United States
(12) Patent Application Publication
(10) Pub. No.: US 2017/0096551 A1
(43) Pub. Date: Apr. 6, 2017

(54) POLYETHYLENE COMPOSITIONS, AND ARTICLES MADE THEREFROM

(71) Applicants: Dow Global Technologies LLC, Midland, MI (US); CD PolyTech Inc., Houston, TX (US)

(72) Inventors: Dane Chang, Sugar Land, TX (US); Stanley P. Dudek, Galveston, TX (US)

(21) Appl. No.: 15/119,504

(22) PCT Filed: Feb. 10, 2015
(86) PCT No.: PCT/US2015/015169

§ 371 Date: Aug. 17, 2016

(51) Int. Cl. C08L 23/06

(52) U.S. Cl. CPC C08L 23/06; C08L 2203/18; C08L 2205/025; C08L 2205/03; C08L 2207/062

(57) ABSTRACT

The invention provides a composition comprising a blend, the blend comprising a polyethylene resin comprising a first molecular weight ethylene-based polymer component and a second molecular weight ethylene-based polymer component, wherein the polyethylene resin has a density from 0.940 to 0.960 g/cc, and an ultra-high molecular weight ethylene-based polymer having an intrinsic viscosity from 5 to 50 deciliters/gram.

### FIELD

Embodiments of the present disclosure generally relate to polyethylene compositions and applications of the polyethylene compositions to make shaped articles, such as, for example, pipes.

### BACKGROUND

Pipes manufactured from polyolefins, for example, HDPE resins, are relatively light in weight, easy to handle, and are non-corrosive. Existing polyolefin pipes can provide a relatively high rigidity, allowing them to be laid under the ground, and a relatively high flexibility so that they can adapt to the movement of ground. However, existing pipes used to transport slurry or other abrasive particulate streams can be subjected to a high degree of wear. In some applications, existing pipes may not be adequate to handle the transport of slurry or abrasive particulate streams. For example, HDPE pipes may not be capable of transporting gritty water-based slurries, such as mining slurries, or petroleum-based and/or solvent-based slurries. Accordingly, these transport applications may require the use of pipes having high abrasion resistance.

Pipes may also be used in high temperature applications, where the pipes transport high temperature materials, and/or are subjected to environmental conditions that can cause pipes to have premature mechanical failures. Existing pipes may not be adequate to transport such slurries or other abrasive particulate streams at elevated temperature, such as, for example, 60° C. (140° F.). Material selection can be critical not only to provide the desired chemical and mechanical properties, but to also provide good abrasive and thermal properties, as well as good processability in manufacturing pipe.

Accordingly, alternative polyethylene compositions having good abrasive and thermal properties, as well as good processability, are desired.

### SUMMARY

Disclosed in embodiments herein are compositions comprising a blend, the blend comprising a polyethylene resin having a density of 0.940-0.960 g/cc and an ultra-high molecular weight ethylene-based polymer having an intrinsic viscosity from 5 to 50 deciliters/gram. The polyethylene resin comprises a first molecular weight ethylene-based polymer component and a second molecular weight ethylene-based polymer component. Also disclosed herein are articles comprising at least one component formed from such compositions.

Additional features and advantages of the embodiments will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing and the following description describe various embodiments and are intended to provide an overview or framework for understanding the nature and character of the claimed subject matter.

### DETAILED DESCRIPTION

Reference will now be made in detail to embodiments of polyethylene compositions comprising a blend, the blend comprising a polyethylene resin and an ultra-high molecular weight ethylene-based polymer. The polyethylene resin comprises a first molecular weight ethylene-based polymer component and a second molecular weight ethylene-based polymer component. As used herein, “blend” or “polymer blend” refers to a composition containing two or more polymers. Such a blend may or may not be miscible, may or may not be phase separated, or may or may not contain one or more domain configurations, as determined from transmission electron microscopy, light scattering, x-ray scattering, and other suitable method known in the art. As used herein, “ethylene-based polymer” refers to a polymer that comprises, in polymerized form, a majority weight percent ethylene (based on the weight of polymer), and, optionally, one or more additional comonomers. The polyethylene resin may comprise a combination of two or more embodiments as described herein.

In embodiments herein, the first molecular weight ethylene-based polymer component of the polyethylene resin may be an ethylene-based interpolymer, ethylene/α-olefin interpolymer, homogeneously branched ethylene-based interpolymer or copolymer, or a heterogeneously branched ethylene-based interpolymer or copolymer. Homogeneously branched interpolymers may be produced, for example, by single-site catalyst systems, and contain a substantially homogeneous distribution of comonomer among the molecules of the interpolymer. Heterogeneously branched interpolymers may typically be produced by Ziegler-Natta type catalysts, and contain a non-homogeneous distribution of comonomer among the molecules of the interpolymer. The comonomer may be an α-olefin. In some embodiments, the first molecular weight ethylene-based polymer component is an ethylene/α-olefin interpolymer, and further an ethylene/α-olefin copolymer. In other embodiments, the first molecular weight ethylene-based polymer component is an ethylene/1-hexene copolymer. Trace amounts of impurities, for example, catalyst residues, may be incorporated into and/or within a polymer.

As used herein, “interpolymer” refers to polymers prepared by the polymerization of at least two different types of monomers. The term “interpolymer” can include copolymers, which is used to refer to polymers prepared from two different types of monomers, and polymers prepared from more than two different types of monomers. As used herein, the term “ethylene-based interpolymer” refers to an interpolymer that comprises, in polymerized form, a majority weight percent ethylene (based on the weight of interpolymer), and one or more additional comonomers. The term “ethylene/α-olefin interpolymer” refers to an ethylene-based polymer that comprises, in polymerized form, a majority weight percent ethylene (based on the weight of interpolymer), an α-olefin comonomer, and optionally, one or more additional comonomers.

Suitable α-olefins may include those containing 3 to 20 carbon atoms (C3-C20). In some embodiments, the α-olefin may be a C4-C20 α-olefin, a C4-C12 α-olefin, a C3-C10 α-olefin, a C3-C8 α-olefin, a C4-C8 α-olefin, or a C6-C8 α-olefin. In some embodiments, α-olefins are selected from the group consisting of propylene, 1-butene, 1-pentene, 1-hexene, 4-methyl-1-pentene, 1-heptene, 1-octene, 1-nonene and 1-decene. In other embodiments, α-olefins are selected from the group consisting of propylene, 1-butene, 1-hexene, and 1-octene. In further embodiments, α-olefins are selected from the group consisting of 1-hexene and 1-octene. In even further embodiments, the α-olefin is 1-hexene.

Exemplary ethylene/α-olefin interpolymers may include, but are not limited to, ethylene/butene-1 (EB) copolymers, ethylene/hexene-1 (EH) copolymers, ethylene/octene-1 (EO) copolymers, ethylene/alpha-olefin/diene modified (EAODM) interpolymers such as ethylene/propylene/diene modified (EPDM) interpolymers and ethylene/propylene/octene terpolymers. In some embodiments, the ethylene/α-olefin interpolymers are selected from the group consisting of EB, EH and EO copolymers. In other embodiments, the ethylene/α-olefin interpolymers are selected from the group consisting of EH and EO copolymers. In further embodiments, the ethylene/α-olefin interpolymer is EH.

In embodiments herein, the density of the first molecular weight ethylene-based polymer component is from 0.910 to 0.940 g/cc. All individual values and subranges of 0.910 to 0.940 g/cc are included and disclosed herein. For example, in some embodiments, the density of the first molecular weight ethylene-based polymer component is from 0.915 to 0.940 g/cc. In other embodiments, the density of the first molecular weight ethylene-based polymer component is from 0.920 to 0.940 g/cc. In further embodiments, the density of the first molecular weight ethylene-based polymer component is from 0.920 to 0.935 g/cc. Densities disclosed herein for ethylene-based polymers are determined according to ASTM D-792.

In embodiments herein, the first molecular weight ethylene-based polymer component has a weight average molecular weight (Mw) of greater than 50,000 g/mole to less than or equal to 450,000 g/mole. All individual values and subranges of greater than 50,000 g/mole to less than or equal to 450,000 g/mole are included and disclosed herein. For example, in some embodiments, the first molecular weight ethylene-based polymer component may have a weight average molecular weight (Mw) of greater than or equal to 100,000 g/mole to less than or equal to 400,000 g/mole. In other embodiments, the first molecular weight ethylene-based polymer component may have a weight average molecular weight (Mw) of greater than 200,000 g/mole to less than or equal to 400,000 g/mole. In further embodiments, the first molecular weight ethylene-based polymer component may have a weight average molecular weight (Mw) of greater than 300,000 g/mole to less than or equal to 400,000 g/mole. The weight average molecular weight may be determined by either Gel Permeation Chromatography (GPC) or light scattering according to the Standard Test Method ASTM D-4001-93 (1999).

In embodiments herein, the first molecular weight ethylene-based polymer component has a molecular weight distribution (MWD) of 4.0 to 8.0. All individual values and subranges of 4.0 to 8.0 are included and disclosed herein. For example, in some embodiments, the first molecular weight ethylene-based polymer component may have a MWD of 5.0 to 7.0. In some embodiments, the first molecular weight ethylene-based polymer component may have a MWD of 4.0 to 6.0. In other embodiments, the first molecular weight ethylene-based polymer component may have a MWD of 4.0 to 5.0. As used herein, MWD refers to the ratio of weight average molecular weight (Mw) to number average molecular weight (Mn), that is, (Mw/Mn). The MWD may be determined by gel permeation chromatography (GPC), as discussed above.

In embodiments herein, the first molecular weight ethylene-based polymer component differs from the second molecular weight ethylene-based polymer component in one or more properties, such as, for example, melt index (I₂), high load melt index (I₂₁), density, number average molecular weight (Mn), weight average molecular weight (Mw), and/or MWD. In some embodiments, the first molecular weight ethylene-based polymer component may have a significantly higher weight average molecular weight than the second molecular weight ethylene-based polymer component. The difference in the weight average molecular weights is reflected in the melt indices. Accordingly, the high load melt index, I₂₁ (190° C., 21.6 kg weight) of the first molecular ethylene-based polymer is 0.05 to 1.2 g/10 min. All individual values and subranges of 0.05 to 1.2 g/10 min are included and disclosed herein. For example, in some embodiments, the high load melt index, I₂₁ of the first molecular ethylene-based polymer is 0.10 to 1.0 g/10 min. In other embodiments, the high load melt index, I₂₁ of the first molecular ethylene-based polymer is 0.10 to 0.80 g/10 min. In further embodiments, the high load melt index, I₂₁ of the first molecular ethylene-based polymer is 0.20 to 0.60 g/10 min.

In embodiments herein, the second molecular weight ethylene-based polymer component may be an ethylene homopolymer, an ethylene-based interpolymer, ethylene-based copolymer, ethylene/α-olefin interpolymer, or a heterogeneously branched ethylene-based interpolymer or copolymer. The comonomer may be an α-olefin as described herein. In some embodiments, the second molecular weight ethylene-based polymer component is an ethylene-based interpolymer. In other embodiments, the second molecular weight ethylene-based polymer component is ethylene/1-hexene copolymer. In other embodiments, the second molecular weight ethylene-based polymer component is a polyethylene homopolymer. In further embodiments, the second molecular weight ethylene-based polymer component is a mixture of a polyethylene homopolymer and an ethylene/α-olefin interpolymer.

The second molecular weight ethylene-based polymer component may have a weight average molecular weight (Mw) of less than 50,000 g/mole. All individual values and subranges of less than 50,000 g/mole are included and disclosed herein. For example, in some embodiments, the second molecular weight ethylene-based polymer component may have a weight average molecular weight (Mw) of less than or equal to 40,000 g/mole, less than or equal to 30,000 g/mole, or less than or equal to 20,000 g/mole. In other embodiments, the second molecular weight ethylene-based polymer component may have a weight average molecular weight (Mw) of greater than or equal to 1,000 g/mole, greater than or equal to 2,000 g/mole, or greater than or equal to 3,000 g/mole. In further embodiments, the second molecular weight ethylene-based polymer component may have a weight average molecular weight (Mw) of greater than 1,000 g/mole to less than or equal to 30,000 g/mole. In even further embodiments, the second molecular weight ethylene-based polymer component may have a weight average molecular weight (Mw) of greater than 1,000 g/mole to less than or equal to 20,000 g/mole.

In embodiments herein, the density of the second molecular weight ethylene-based polymer component is from 0.950 to 0.990 g/cc. All individual values and subranges of 0.950 to 0.990 g/cc are included and disclosed herein. For example, in some embodiments, the density of the second molecular weight ethylene-based polymer component is from 0.955 to 0.985 g/cc. In other embodiments, the density of the second molecular weight ethylene-based polymer component is from 0.960 to 0.980 g/cc. In further embodiments, the density of the second molecular weight ethylene-based polymer component is from 0.965 to 0.978 g/cc. The density of the second molecular weight ethylene-based polymer component may be determined from the following equation:

$$\frac{1}{Density ( PE )} = \frac{Weight Fraction ( A )}{Density ( A )} + \frac{Weight Fraction ( B )}{Density ( B )} \qquad ( I )$$

wherein “A” is the first molecular weight ethylene-based polymer component, “B” is the second molecular weight ethylene-based polymer component, and “PE” is the polyethylene resin.

In embodiments herein, the polyethylene resin has a density greater than, or equal to, 0.940 g/cc, greater than, or equal to, 0.945 g/cc, or greater than, or equal to, 0.948 g/cc. In other embodiments, the polyethylene resin has a density less than, or equal to, 0.960 g/cc, or less than, or equal to, 0.955 g/cc. All individual values and subranges of greater than, or equal to, 0.940 g/cc and less than, or equal to, 0.960 g/cc, are included and disclosed herein. For example, in some embodiments, the polyethylene resin has a density of 0.940 to 0.960 g/cc, 0.945 to 0.960 g/cc, 0.945 to 0.955 g/cc, or 0.945 to 0.950 g/cc.

In embodiments herein, the polyethylene resin has a high load melt index (I21) less than, or equal to, 20 g/10 min, less than, or equal to, 15 g/10 min, or less than, or equal to, 10 g/10 min. In other embodiments, the polyethylene resin has a high load melt index (I21) greater than, or equal to, 1 g/10 min, greater than, or equal to, 3 g/10 min, or greater than, or equal to, 5 g/10 min. All individual values and subranges of greater than, or equal to, 1 g/10 min and less than, or equal to, 20 g/10 min, are included and disclosed herein. For example, in some embodiments, the polyethylene resin has a high load melt index (I21) from 1 to 20 g/10 min, from 2 to 15 g/10 min, from 3 to 12 g/10 min, or from 4 to 10 g/10 min.

In embodiments herein, the polyethylene resin has a MWD of 10 to 30. All individual values and subranges of 10 to 30 are included and disclosed herein. For example, in some embodiments, the polyethylene resin may have a MWD of 15 to 25. As used herein, MWD refers to the ratio of weight average molecular weight (Mw) to number average molecular weight (Mn), that is, (Mw/Mn). The MWD may be determined by gel permeation chromatography (GPC), as discussed above.

The polyethylene resin may comprise any amount of the first molecular weight ethylene-based polymer component or the second molecular weight ethylene-based polymer component. In some embodiments, either component can be present, independently, in amounts of 0.5% to 99.5%, by weight of the polyethylene resin. All individual values and subranges of 0.5% to 99.5% are included and disclosed herein. For example, in some embodiments, the polyethylene resin comprises 30% to 70%, by weight of the polyethylene resin, 35% to 65%, by weight of the polyethylene resin, or 40% to 60%, by weight of the polyethylene resin, of the first molecular weight ethylene-based polymer component. In other embodiments, the polyethylene resin comprises 30% to 70%, by weight of the polyethylene resin, 35% to 65%, by weight of the polyethylene resin, or 40% to 60%, by weight of the polyethylene resin, of the second molecular weight ethylene-based polymer component. In further embodiments, the weight ratio of the first molecular weight ethylene-based polymer component to the second molecular weight ethylene-based polymer is from 0.4 to 2.3. In even further embodiments, the weight ratio of the first molecular weight ethylene-based polymer component to the second molecular weight ethylene-based polymer is from 0.6 to 2.0. In even further embodiments, the weight ratio of the first molecular weight ethylene-based polymer component to the second molecular weight ethylene-based polymer is from 0.8 to 1.5.

In embodiments herein, the polyethylene resin may comprise an Mw of the first molecular weight ethylene-based polymer component that is greater than the Mw of the second molecular weight ethylene-based polymer component. In some embodiments, the Mw of the first molecular weight ethylene-based polymer component is at least twice the Mw of the second molecular weight ethylene-based polymer component. In other embodiments, the Mw of the first molecular weight ethylene-based polymer component is at least ten times the Mw of the second molecular weight ethylene-based polymer component. In further embodiments, the Mw of the first molecular weight ethylene-based polymer component is at least twenty times the Mw of the second molecular weight ethylene-based polymer component.

In embodiments herein, the polyethylene resin can be made by a variety of methods. For example, it may be made by blending or mixing the first molecular weight ethylene-based polymer component and the second molecular weight ethylene-based polymer component together. Alternatively, the polyethylene resin may be made in a single reactor or a multiple reactor configuration, where the multiple reactors may be arranged in series or parallel, and where each polymerization takes place in solution, in slurry, or in the gas phase. In some embodiments, a dual reactor configuration is used where the polymer made in the first reactor can be either the first molecular weight ethylene-based polymer component or the second molecular weight ethylene-based polymer component. The polymer made in the second reactor may have a density and melt flow rate such that the overall density and melt flow rate of the polyethylene resin are met. In some embodiments, the first molecular weight ethylene-based polymer component is made in the first reactor, and the second molecular weight ethylene-based polymer component is made in the second reactor. Similar polymerization processes are described in, for example, WO 2004/101674A, which is incorporated herein by reference.

In some embodiments, the polyethylene resin is manufactured using at least one Ziegler-Natta catalyst system, either alone, or in combination with a single site catalyst. In other embodiments, the polyethylene resin is manufactured using multiple reactors in series with a Z-N catalyst being fed to either each reactor or to just the first reactor. In further embodiments, the Z-N catalyst system may be fed into one or two independently-controlled reactors configured sequentially, and operated in solution, slurry or gas phase. Sequential polymerization may be conducted such that fresh catalyst is injected into one reactor, and substantially little active catalyst is carried over from the first reactor into the second reactor. The resulting polyethylene resin may be characterized as comprising component polymers, each having distinct, unimodal molecular weight distributions. As used herein, “distinct,” when used in reference to the molecular weight distribution of the first molecular weight ethylene-based polymer component and the second molecular weight ethylene-based polymer component means there are two corresponding molecular weight distributions in the resulting GPC curve of the polyethylene resin. As used herein, “unimodal,” when used in reference to the molecular weight distribution of a component polymer of the polyethylene resin means the molecular weight distribution in a GPC curve of the component polymer does not substantially exhibit multiple component polymers.

The ultra-high molecular weight ethylene-based polymers described herein may be a polyethylene homopolymer or ethylene/alpha-olefin copolymer, each having an ultra-high molecular weight. The ultra-high molecular weight ethylene-based polymer has a higher molecular weight than the first molecular weight ethylene-based polymer component, second molecular weight ethylene-based polymer component, and/or polyethylene resin. This may be indicated by melt index (I₂), high load melt index (I₂₁), a viscosity measurement (e.g., intrinsic or melt viscosity), and/or GPC. Suitable copolymers may include alpha-olefins having 3 to 10 carbon atoms or, in some embodiments, 3 to 5 carbon atoms. In some embodiments, the ethylene/alpha-olefin copolymer may comprise up to about 5 mol. % of the alpha-olefin comonomer, up to about 2 mol. %. of the alpha-olefin comonomer, or up to about 1 mol. % of the alpha-olefin comonomer. Suitable ultra-high molecular weight ethylene-based polymers may include, but is not limited to, the GUR® 4050 polymer available from Ticona Engineering Polymers, and the UTEC® 6540 polymer available from Braskem.

In embodiments herein, the ultra-high molecular weight ethylene-based polymer has an intrinsic viscosity of at least 5 deciliters/gram. All values and subranges are included herein. For example, in some embodiments, the ultra-high molecular weight ethylene-based polymer has an intrinsic viscosity of at least 7 deciliters/gram, at least 10 deciliters/gram, or at least 12 deciliters/gram. There is no particular restriction on the upper limit of the intrinsic viscosity. In other embodiments, the ultra-high molecular weight ethylene-based polymer has an intrinsic viscosity from 5 to 50 deciliters/gram, 5 to 40 deciliters/gram, 7 to 40 deciliters/gram, or 10 to 30 deciliters/gram. The intrinsic viscosity may be determined in accordance with ASTM D 4020.

In embodiments herein, the ultra-high molecular weight ethylene-based polymer has an average particle size, D50, from 170-210 micrometers. All values and subranges are included herein. For example, in some embodiments, the ultra-high molecular weight ethylene-based polymer has an average particle size, D50, from 180-200 micrometers. In other embodiments, the ultra-high molecular weight ethylene-based polymer has an average particle size, D50, from 185-195 micrometers. In further embodiments, the ultra-high molecular weight ethylene-based polymer has an average particle size, D50, of about 190 micrometers. The average particle size may be determined in accordance with ASTM D1921.

In embodiments herein, the ultra-high molecular weight ethylene-based polymer has a melt temperature from 125 to 140° C. All values and subranges are included herein. For example, in some embodiments, the ultra-high molecular weight ethylene-based polymer has a melt temperature from 125 to 140° C. In other embodiments, the ultra-high molecular weight ethylene-based polymer has a melt temperature from 128 to 138° C. In further embodiments, the ultra-high molecular weight ethylene-based polymer has a melt temperature of 130 to 135° C. The melt temperature may be determined using differential scanning calorimetry (DSC) in accordance with ASTM D3418.

In embodiments herein, the ultra-high molecular weight ethylene-based polymer may have a weight average molecular weight greater than or equal to 1,000,000 g/mole. In some embodiments, the ultra-high molecular weight ethylene-based polymer may have a weight average molecular weight greater than or equal to 2,000,000 or greater than or equal to 3,000,000 g/mole. In other embodiments, the ultra-high molecular weight ethylene-based polymer may have a weight average molecular weight less than or equal to 10,000,000 g/mole. In further embodiments, the ultra-high molecular weight ethylene-based polymer may have a weight average molecular weight greater than or equal to 1,000,000 g/mole and less than or equal to 10,000,000 g/mole, greater than or equal to 2,000,000 g/mole and less than or equal to 10,000,000 g/mole, greater than or equal to 3,000,000 g/mole and less than or equal to 9,000,000 g/mole, or greater than or equal to 3,000,000 g/mole and less than or equal to 8,000,000 g/mole. The weight average molecular weight may be determined by GPC or light scattering.

In embodiments herein, the ultra-high molecular weight ethylene-based polymer may have a density from 0.915 to 0.950 g/cc. All values and subranges are included herein. For example, in some embodiments, the ultra-high molecular weight ethylene-based polymer may have a density from 0.920 to 0.945 g/cc, from 0.920 to 0.940 g/cc, from 0.920 to 0.935 g/cc, from 0.920 to 0.930 g/cc, or from 0.921 to 0.928 g/cc.

In embodiments herein, the weight ratio of polyethylene resin to ultra-high molecular weight ethylene-based polymer in the blend may be from 0.4 to 2.3. All individual values and subranges from 0.4 to 2.3 are included and disclosed herein. For example, in some embodiments, the weight ratio of polyethylene resin to ultra-high molecular weight ethylene-based polymer in the blend is from 0.4 to 2.0, from 0.4 to 1.5, or from 0.4 to 1.0. In other embodiments, the weight ratio of polyethylene resin to ultra-high molecular weight ethylene-based polymer in the blend is from 0.8 to 1.5 or from 0.9 to 1.3.

In embodiments herein, the blend has a high load melt index (I21) from 0.1 to 20 g/10 min. All individual values and subranges from 0.1 to 20 g/10 min are included and disclosed herein. For example, in some embodiments, the blend has a high load melt index (I21) from 0.3 to 12.0 g/10 min. In other embodiments, the blend has a high load melt index (I21) from 0.4 to 8.0 g/10 min. In further embodiments, the blend has a high load melt index (I21) from 0.5 to 5.0 g/10 min. In even further embodiments, the blend has a high load melt index (I21) from 0.3 to 3.0 g/10 min, from 0.3 to 2.5, or from 0.8 to 2.5.

In embodiments herein, the composition may further comprise a second blend, which comprises the following components, A-C: A) a polyethylene resin comprising a first molecular weight ethylene-based polymer component and a second molecular weight ethylene-based polymer component, wherein the polyethylene resin has a density from 0.940 to 0.960 g/cc; B) an ultra-high molecular weight ethylene-based polymer having an intrinsic viscosity from 5 to 50 deciliters/gram; and C) a fluoropolymer. Exemplary polyethylene resins, ultra-high molecular weight ethylene-based polymers and fluoropolymers suitable for use in the second blend have been previously described herein and may be selected independently from the polyethylene resins, ultra-high molecular weight ethylene-based polymers and fluoropolymers included in the blend.

The second blend may have a weight ratio of component A to component B of 0.8 to 0.5. All individual values and subranges from 0.8 to 0.5 are included and disclosed herein. For example, in some embodiments, the second blend has a weight ratio of component A to component B of 0.7 to 0.5. The second blend may have a high load melt index (I21) from 0.7 to 5.0 g/10 min. All individual values and subranges from 0.7 to 5.0 g/10 min are included and disclosed herein. For example, in some embodiments, the second blend may have a high load melt index (I21) from 1.0 to 3.0 g/10 min.

In embodiments herein, the weight ratio of the blend to the second blend may be from 0.7 to 1.5. All individual values and subranges from 0.7 to 1.5 are included and disclosed herein. For example, in some embodiments, the weight ratio of the blend to the second blend may be from 0.8 to 1.3. In other embodiments, the weight ratio of the blend to the second blend may be from 0.9 to 1.1.

In embodiments herein, the ratio of the I₂₁ of the second blend to the I₂₁ of the blend is from 2 to 10. All individual values and subranges from 2 to 10 are included and disclosed herein. For example, in some embodiments, the ratio of the I₂₁ of the second blend to the I₂₁ of the blend is from 3 to 9. In other embodiments, the ratio of the I₂₁ of the second blend to the I₂₁ of the blend is from 4 to 8. In further embodiments, the ratio of the I₂₁ of the second blend to the I₂₁ of the blend is from 5 to 7.

The compositions described herein may contain one or more additives. Additives include, but are not limited to, processing aids, acid neutralizers, UV stabilizers, hydro peroxide decomposers, alkyl radical scavengers, hindered amine stabilizers, multifunctional stabilizers, phosphites, antioxidants, process stabilizers, metal de-activators, additives to improve oxidative or chlorine resistance, pigments or colorants, nucleating agents, fatty acid stearates, fluoroelastomers, fillers, and combinations thereof.

In embodiments herein, the compositions may contain one or more processing aids. In some embodiments, the processing aid may comprise one or more fluoropolymers. Without being bound by theory, it is believed that the inclusion of one or more fluoropolymers in the compositions described herein improves processability of the composition, by lowering the apparent melt viscosity of the composition to reduce build up at an extrusion die. Additionally, the inclusion of one or more fluoropolymers in the compositions described herein does not adversely affect the mechanical properties of the compositions. Suitable fluoropolymers may include, but are not limited to, vinylidene fluoride, hexafluoropropylene, chlorotrifluoroethylene, tetrafluoroethylene, perfluoroalkyl perfluorovinyl ethers, 1-hydropentafluoropropylene, 2-hydropentafluoropropylene, and combinations thereof. Other examples of suitable fluoropolymers may include, but are not limited to, copolymers of vinylidene fluoride and one or more comonomers selected from hexafluoropropylene, chlorotrifluoroethylene, 1-hydropentafluoropropylene, and 2-hydropentafluoropropylene. Further examples of suitable fluoropolymers may include, but are not limited to, copolymers of tetrafluoroethylene and one or more comonomers selected from hexafluoropropylene and vinylidene fluoride. In some examples, the fluoropolymers may further be blended with olefins, such as, for example, propylene, or a polyether, such as for example, polyethylene oxide. In some embodiments, the fluoropolymer is selected from the group consisting of vinylidene fluoride/hexafluoropropylene, vinylidene fluoride/hexafluoropropylene/tetrafluoro ethylene, tetrafluoroethylene, tetrafluoroethylene/propylene, tetrafluoroethylene/propylene/vinylidene fluoride, or vinylidene fluoride/hexafluoropropylene/polyethylene oxide. In other embodiments, the fluoropolymer is selected from the group consisting of vinylidene fluoride/hexafluoropropylene, vinylidene fluoride/hexafluoropropylene/tetrafluoroethylene, tetrafluoroethylene/propylene/vinylidene fluoride, or vinylidene fluoride/hexafluoropropylene/polyethylene oxide. In further embodiments, the fluoropolymer is vinylidene fluoride/hexafluoropropylene/tetrafluoroethylene.

The fluoropolymer described herein may also be characterized by one or more properties. In some embodiments, the fluoropolymers employed in the compositions described herein may have a melting point of 100 to 135° C., as measured by the differential scanning calorimetry (DSC) according to ASTM D4591-07. In some embodiments, the fluoropolymers employed in the compositions described herein may have a density of 1.80 to 2.20 g/cc. In some embodiments, the fluoropolymers employed in the compositions described herein may have a melt flow index (265° C.; 5 kg) of 2.0 to 20.0 g/10 min. The melt flow index (MFI) may be determined according to ASTM D1238 at 265° C., 5.0 kg. The one or more fluoropolymers may be employed in the compositions such that the total fluoropolymer level is from 50 to 5000 ppm, from 100 to 3000, from 150 to 2000, or from 250 to 1000 ppm. Without being bound by theory, it is believed that incorporation of one or more fluoropolymers into the compositions described herein can contribute to better abrasion resistant properties by reducing the coefficient of friction at the surface of the compositions described herein.

The compositions described herein may be characterized by exceptional resistance to slow crack growth as measured by the PENT test. In embodiments herein, the composition may have a PENT lifetime of greater than, or equal to, 100 hours, greater than, or equal to, 500 hours, or greater than, or equal to, 1000 hours, at 2.4 MPa and 80° C. using ASTM F1473-11. All individual values and subranges of greater than, or equal to, 500 hours are included and disclosed herein. For example, in some embodiments, the compositions have a PENT lifetime of greater than, or equal to 3,000 hours, at 2.4 MPa and 80° C. using ASTM F1473-11.

The compositions described herein may be manufactured by a method comprising obtaining a blend comprising the ultra-high molecular weight ethylene-based polymer and the polyethylene resin (as described herein), wherein the amount of polyethylene resin is greater than 50 wt. % of the blend; obtaining a second blend comprising the ultra-high molecular weight ethylene-based polymer and the polyethylene resin (as described herein), wherein the amount of ultra-high molecular weight ethylene-based polymer is greater than 50 wt. % of the second blend; and mixing the blend and the second blend to form a composition. Preparation of the blend and second blend can be accomplished by any suitable mixing means known in the art, including melt or dry/physical blending of the individual components. It should be understood that other suitable methods for blending the ultra-high molecular weight ethylene-based polymer and the polyethylene resin together may be utilized.

In embodiments herein, the ultra-high molecular weight ethylene-based polymer and the polyethylene resin may be blended under high shear conditions. In some embodiments, the ultra-high molecular weight ethylene-based polymer and the polyethylene resin may be blended at a shear rate of greater than or equal to 5/sec, greater than or equal to 10/sec, greater than or equal to 20/sec, or greater than or equal to 50/sec. In other embodiments, the ultra-high molecular weight ethylene-based polymer and the polyethylene resin may be blended at a shear rate of greater than or equal to 5/sec to less than or equal to 1000/sec. All individual values and subranges of greater than or equal to 5/sec and less than or equal to 1000/sec are included and disclosed herein. It should be understood that various shear rate combinations (e.g., a shear rate of 5/sec for a period of time, then change to a shear rate of 50/sec for a period of time) may also be used.

It has been found that due to the extremely high molecular weight of ultra-high molecular weight ethylene-based polymer, which affects the melt viscosity, conventional processing equipment cannot be used to process such polymers. However, the compositions and methods described herein can allow for decreased mixing time and/or use of standard processing equipment, wherein the composition may be processed on standard plastic processing equipment, such as, for example, single or twin screw extruders and/or injection molding machines. It has also been found that pipes made with HDPE resins can be inadequate to handle the transport of slurry or abrasive particulate streams. Without being bound by theory, it is believed that the compositions described herein have improved abrasive properties and better processability when the polyethylene resin and the ultra-high molecular weight ethylene-based polymer are blended under high shear conditions, which can cause crosslinking or partial crosslinking between the polyethylene resin and the ultra-high molecular weight ethylene-based polymer resulting in higher weight average molecular weight molecules as compared to the individual components (i.e., polyethylene resin and the ultra-high molecular weight ethylene-based polymer).

The compositions described herein can be used to manufacture a shaped article, or one or more components of a shaped article. Such articles may be single-layer or multi-layer articles, which may be obtained by suitable known conversion techniques, applying heat, pressure, or a combination thereof, to obtain the desired article. Examples of suitable conversion techniques may include, for example, blow-molding, co-extrusion blow-molding, injection molding, injection stretch blow molding, compression molding, extrusion, pultrusion, calendering and thermoforming. Shaped articles may include, for example, pipes, pipe coatings (for example, steel pipe coatings), blow molded articles, injection molded articles, compression molded articles, drip tapes and tubings, geomembranes, films, sheets, fibers, profiles and moldings.

In some embodiments, the compositions described herein may be particularly well-suited for use in manufacturing durable pipes. Pipes can include monolayer pipes, as well as multilayer pipes, including multilayer composite pipes. Pipes formed from the compositions described herein may also contain a suitable combination of additives and/or fillers designed for pipe applications.

The embodiments described herein may be further illustrated by the following non-limiting examples.

### Examples

Unless otherwise stated, the following test methods are used. All test methods are current as of the filing date of this disclosure.

### Melt Index

Melt index, or 12, for ethylene-based polymers is determined according to ASTM D1238 at 190° C., 2.16 kg. High load melt index, or I21, for ethylene-based polymers is determined according to ASTM D1238 at 190° C., 21.6 kg.

### PENT (Pennsylvania Notch Test) for Slow Crack Growth Resistance

The Pennsylvania Notch Test (PENT), a slow crack growth resistance test, was performed, following the procedure described by in ASTM F-1473-11, at 80° C. and 2.4 MPa, unless otherwise specified. In the PENT method, a single edge notched test specimen is exposed to a constant load in an oven under a well-controlled temperature. The time to failure can be measured with a timer, and the rate of failure can be measured with a microscope or a dial gauge. The notch depth is generally about 35% of the sample thickness. The width of the notch may vary from about 15 to about 25 mm, and the side grooves can vary from about 0.5 to about 1.0 mm, depending on the width of the specimen.

In the PENT test, a notch is made in the sample by pressing a fresh razor blade into the specimen at a speed of less than 0.25 mm/min. Speeds of less than 0.25 mm/min avoid notch tip damage and still provide a reasonably short notching time. At notching speeds of greater than about 525 μm/min, the failure time is significantly increased. Notching speeds for the side grooves is not particularly important. The apparatus should ensure that the notch and side grooves are coplanar.

During testing, care should be taken to ensure that the specimen grips are appropriately arranged. To that end, the grips should be aligned and centered with respect to the longitudinal axis of the specimen. During gripping the notch should not be activated by bending or twisting the specimen. An alignment jig may be used to aid in properly gripping the specimen, to align the grips, and to avoid bending or twisting the specimen. In addition, the grips should have serrated faces to prevent slippage, and the ends of the grips should be at least 10 mm from the notch.

The testing apparatus may be a direct loading device or a lever loading device. A 5:1 a lever on ratio has been found to be very convenient. The grips may be attached to the loading machine by tabs, which have a universal action such that the applied to load is pure tension.

### Melting Point

Melting points of ethylene-based polymers were determined by differential scanning calorimeter according to ASTM D3418.

### Abrasion Resistance Test

A Sand Slurry Test Rig, similar to that described in ISO-15527, was used for abrasion resistance test. The test rig was 10 inches deep by 6 inches in internal diameter. The test rig contained two kilograms of 16 grit aluminum oxide (Alox 16) and two kilograms of water, which filled the bottom five inches of the vessel. A test coupon was attached to the bottom of an eight inch shaft that rotated the test coupon two inches above the bottom of the test rig at about 1,750 rpm. The testing was done in triplicate for two hours at room temperature. The test produced significant, but reproducible wear on the test coupon. For each test, fresh grit and water were used.

The weight of each test coupon was measured before and after the abrasion test. The weight loss was calculated as follows: [Before Abrasion Weight, g]−[After Abrasion Weight, g]=Weight Loss. The Average Weight Loss was calculated as follows: [Sum of Each Weight Loss Measurement]/[Number of Measurements]. The endpoints of the Range of Loss were selected from the lowest and highest Weight Loss values.

The following materials are used in the Example described below.

### Inventive Example—Preparation of Composition

A polyethylene resin comprising a first molecular weight ethylene-based polymer component and a second molecular weight ethylene-based polymer component, and having a high load melt index, I₂₁, of 7.0 and a density of 0.949 g/cc (DGDA 2490 NT, available from the Dow Chemical Company, USA) was blended at a 1:1 weight ratio with an ultra-high molecular weight ethylene-based polymer having a weight average molecular weight of 3,000,000 g/mole, a density of 0.925 g/cc, and an intrinsic viscosity of 14 dL/g (UTEC 6540, available from Braskem, Brazil) to form a blend. The blend was compounded with 5,000 ppm of a fluoropolymer process aid (Dynamar FX 5911, available from 3M, Inc., USA), using a Dr. Collin 25 mm twin screw, at the following processing parameters to produce uniform pellets.

Barrel Temperatures:

| | | | | |
|---|---|---|---|---|
| 190° C. | 240° C. | 280° C. | 280° C. | 280° C. |

Screw RPM: 170; Torque: 75%; Melt Temperature: 296° C.

The HLMI (I₂₁) of the pellets from the first blend was determined to be 0.4 g/10 min.

The polyethylene resin having a high load melt index of 7.0 and a density of 0.949 g/cc, and the ultra-high molecular weight ethylene-based polymer having a weight average molecular weight of 3,000,000 g/mole, a density of 0.925 g/cc, and an intrinsic viscosity of 14 dL/g were blended at a weight ratio of 1:1.85 (polyethylene resin:ultra-high molecular weight ethylene-based polymer) to form a second blend. The second blend was compounded with 5,000 ppm of the fluoropolymer process aid, as described above for the first blend, but the second blend reached a melt temperature of 304° C. The HLMI (I₂₁) of the pellets from the second blend was determined to be 2.1 g/10 min.

The blend and the second blend were tumble blended together at ambient temperature and atmosphere, at a 1:1 weight ratio to form a composition. The composition was compression molded into 10″×10″ plaques (10 mm thick), and then cut into 4″×1″ test coupons. The details of the compression molding procedure are described in ASTM D4703.

### COMPARATIVE EXAMPLES

### Comparative Example 1

a polyethylene having a melt index of 0.08 and a density of 0.949 g/cc (DGDA 2490 NT, available from the Dow Chemical Company, USA). The polyethylene resin was compression molded per ASTM D4703 into 10″×10″ plaques (10 mm thick) and then cut into 4″×1″ test coupons.

### Comparative Example 2

a ultra-high molecular weight ethylene-based polymer having a weight average molecular weight of 4,000,000 (GUR 4050, available from Ticona Engineering Polymers, USA). The ultra-high molecular weight polyethylene was compression molded per ASTM D4703 into 10″×10″ plaques (10 mm thick) and then cut into 4″×1″ test coupons.

### Comparative Example 3

a ultra-high molecular weight polyethylene having a weight average molecular weight of 3,000,000, a density of 0.925 g/cc, and an intrinsic viscosity of 14 dL/g (UTEC 6540, available from Braskem, Brazil). The ultra-high molecular weight polyethylene was compression molded per ASTM D4703 into 10″×10″ plaques (10 mm thick) and then cut into 4″×1″ test coupons.

### PENT Measurement Results

A PENT measurement was performed on the composition from the Inventive Example using the test method described above. The time to failure was >6,000 hours.

### Abrasion Resistance Test Results

TABLE I
Loss Properties (grams) @ Room Temperature in Water

| | | Average Weight | Range of |
|---|---|---|---|
| Material | HLMI | Loss (g) | Loss (g) |
| Inventive Example | 1.5 | 5.7 | 5.3-5.9 |
| Comparative Example 1 | 7.0 | 8.1 | 7.5-8.5 |
| Comparative Example 2 | 0 | 4.9 | 4.4-5.7 |
| Comparative Example 3 | 0 | 4.0 | 3.8-4.3 |

As shown in Table I, the Inventive Example exhibits a higher abrasion resistance when compared to Comparative Example 1, which is the polyethylene resin alone, and does not lose a significant amount of abrasion resistance when compared to Comparative Examples 2 and 3. In addition, the “1.5 HLMI value” for the Inventive Example, when compared to that of zero for both Comparative Examples 2 and 3, show improved processability.

### Pipe Extrusion

A pipe extrusion run was performed using the composition from the Inventive Example on a commercial American Maplan 60 mm groove-feed extruder with a 2 inch IPS (iron pipe size) pipe die. The process conditions are summarized below.

Parameters

| Barrel Zones 1-4 Temperature, ° F. | 430, 450, 460, 460 | |
|---|---|---|
| Die Zones 1-10 Temperature, ° F. | 480 throughout all zones. | |
| Inventive Composition Melt Temperature | 434° | F. |
| Head Pressure | 3038 | psig |
| Screw Speed | 83 | rpm |
| Amp Load | 83% | |
| Vacuum | 14 | in. Hg |
| Output Rate | 310 | lbs/hr |

The pipe produced had an outside diameter of 2.376 inch and a wall thickness of 0.229 inch, which meets ASTM F714 specification for SDR (standard diameter ratio) 11 pipe.

1. A composition comprising a blend, the blend comprising:
a polyethylene resin comprising a first molecular weight ethylene-based polymer component having a density from 0.910 to 0.940 g/cc and a second molecular weight ethylene-based polymer component, wherein the polyethylene resin has a density from 0.940 to 0.960 g/cc; and
an ultra-high molecular weight ethylene-based polymer having an intrinsic viscosity from 5 to 50 deciliters/gram.

2. The composition of claim 1, wherein the polyethylene resin has a high load melt index (I21) from 1 to 20 g/10 min.

3. (canceled)

4. The composition of claim 1, wherein the high load melt index (I21) of the first molecular ethylene-based polymer component is from 0.05 to 1.2 g/10 min.

5. The composition of claim 1, wherein the weight ratio of the first molecular weight ethylene-based polymer component to the second molecular weight ethylene-based polymer component is from 0.4 to 2.3.

6. The composition of claim 1, wherein the density of the ultra-high molecular weight ethylene-based polymer is from 0.920 to 0.945 g/cc.

7. The composition of claim 1, wherein the ultra-high molecular weight ethylene-based polymer has a weight average molecular weight of greater than 1,000,000 g/mole.

8. The composition of claim 1, wherein the weight ratio of the polyethylene resin to the ultra-high molecular weight ethylene-based polymer is from 0.4 to 2.3.

9. The composition of claim 1, wherein the blend has a high load melt index (I21) from 0.1 to 20 g/10 min.

10. The composition of claim 1, further comprising a fluoropolymer.

11. The composition of claim 10, wherein the fluoropolymer has a melting point from 100 to 135° C. (DSC test method).

12. The composition of claim 10, wherein the fluoropolymer has a density from 1.80 to 2.20 g/cc.

13. The composition of claim 10, wherein the fluoropolymer has a melt flow index (265° C.; 5.0 kg) from 2.0 to 20.0 g/10 min.

14. The composition of claim 10, wherein the fluoropolymer is present in an amount from 50 to 5000 ppm, based on the weight of the composition.

15. The composition of claim 1, wherein the weight ratio of the polyethylene resin to the ultra-high molecular weight ethylene-based polymer is from 0.8 to 1.1, further from 0.9 to 1.0; and wherein the blend has a high load melt index (I21) from 0.2 to 0.6 g/10 min, further from 0.3 to 0.5 g/10 min.

16. The composition of claim 1, the composition further comprising a second blend comprising the following components A-C:
A) a polyethylene resin comprising a first molecular weight ethylene-based polymer component and a second molecular weight ethylene-based polymer component, wherein the polyethylene resin has a density from 0.940 to 0.960 g/cc;
B) an ultra-high molecular weight ethylene-based polymer having an intrinsic viscosity from 5 to 50 deciliters/gram; and
C) a fluoropolymer; and
wherein the weight ratio of component A to component B is from 0.8 to 0.5, further from 0.7 to 0.5; and wherein the second blend has a high load melt index (I21) from 0.7 to 5 g/10 min, further from 1.0 to 3.0 g/10 min.

17. The composition of claim 16, wherein the weight ratio of the blend to the second blend is from 0.7 to 1.5.

18. The composition of claim 16, wherein the ratio of the I21 of the second blend to the I21 of the blend is from 2 to 10.

19. The composition of claim 1, wherein the composition has a slow crack growth resistance value, as measured by PENT, of greater than, or equal to, 100 hours (80° C., 2.4 MPa; ASTM F1473-11).

20. A shaped article comprising at least one component formed from the composition of claim 1.

21. The article of claim 20, wherein the shaped article is a pipe.
